(19) United States
(12) Patent Application Publication
(10) Pub. No.: US 2008/0131315 A1
(43) Pub. Date: Jun. 5, 2008

(54) COLOR REACTION DETECTING DEVICE AND METHOD FOR MANUFACTURING SAME

(75) Inventors: Tomohiro Takase, Kanagawa-ken (JP); Isao Nawata, Kanagawa-ken (JP); Ikuo Uematsu, Kanagawa-ken (JP); Masaaki Hirakawa, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/771,533

(22) Filed: Jun. 29, 2007

(30) Foreign Application Priority Data
Jun. 30, 2006 (JP) 2006-181240

(51) Int. Cl. G01N 21/76; G11B 7/00; G11B 20/18

(52) U.S. Cl. 422/52; 369/53.12

(57) ABSTRACT

A color reaction detecting device includes: a support configured to support a sensor chip, the sensor chip including a thin film which causes a color reaction by a substance released from an object under inspection; a light source configured to introduce light into the sensor chip supported by the support; a photodetector configured to sense light emitted from the sensor chip; a temperature sensor configured to measure temperature; and a control unit. The control unit computes an amount of color reaction in the sensor chip using a result of the sensing by the photodetector and a result of the measurement by the temperature sensor.

### CROSS-REFERENCE TO RELATED APPLICATIONS

This application is based upon and claims the benefit of priority from the prior Japanese Patent Application No. 2006-181240, filed on Jun. 30, 2006; the entire contents of which are incorporated herein by reference.

### BACKGROUND OF THE INVENTION

1. Field of the Invention

This invention relates to a color reaction detecting device and a method for manufacturing the same.

2. Background Art

Biosensors are widely used in medical equipment. A color reaction detecting device is one of the measuring instruments based on biosensors. The color reaction detecting device includes a waveguide layer with a thin film provided thereon, and a certain amount of light is guided inside the waveguide layer to measure the intensity of light, that is, the guided light intensity extracted from the waveguide layer.

The thin film placed on the waveguide layer is brought into contact with a biological tissue such as an arm or finger tip. A prescribed substance released from the biological tissue and intruding into the thin film induces color reaction. The light incident on one end of the waveguide layer is absorbed in this color reaction region. The incident light is reflected on the upper and lower surface of the waveguide layer and propagates to the other end of the waveguide layer, but the light intensity is attenuated each time it is absorbed in the color reaction region. Hence, by measuring the amount of this absorption, the amount of color reaction can be determined to serve for the function of a biosensor capable of measuring the prescribed substance released from the biological tissue.

However, in the measurement, the temperature of the color reaction detecting device varies upon contact with a biological tissue such as a human body. In the operating environment susceptible to this temperature variation, the guided light intensity varies. That is, even if the amount of color reaction is constant, the detected guided light intensity may vary and cause errors in the measurement.

JP 2004-113434A discloses a noninvasive blood sugar measuring instrument for measuring blood glucose concentration from outside a human body with improved accuracy.

### SUMMARY OF THE INVENTION

According to an aspect of the invention, there is provided a color reaction detecting device including: a support configured to support a sensor chip, the sensor chip including a thin film which causes a color reaction by a substance released from an object under inspection; a light source configured to introduce light into the sensor chip supported by the support; a photodetector configured to sense light emitted from the sensor chip; a temperature sensor configured to measure temperature; and a control unit configured to compute an amount of color reaction in the sensor chip using a result of the sensing by the photodetector and a result of the measurement by the temperature sensor.

According to another aspect of the invention, there is provided a method for manufacturing a color reaction detecting device, the color reaction detecting device including a support for supporting a sensor chip, a light source for introducing light into the sensor chip supported by the support, a photodetector for sensing light emitted from the sensor chip, a temperature sensor for measuring temperature, a data storage unit, and a control unit for computing an amount of color reaction in the sensor chip, the method including: storing, in the data storage unit, data for correcting errors due to temperature variation which occurrs during the sensing by the photodetector.

### BRIEF DESCRIPTION OF THE DRAWINGS

FIG. 1 is a block diagram of a color reaction detecting device according to an embodiment of the invention.

FIG. 2 is a schematic cross-sectional view showing the optical unit in the color reaction detecting device of this embodiment.

FIG. 3 is a schematic cross-sectional view for illustrating the optical function in more detail.

FIG. 4 is a graph conceptually showing the temporal variation in the intensity of incident light G3 detected by the photodetector 20 in measurement.

FIG. 5 is a flow chart illustrating the flow of measurement in the color reaction detecting device 1 of this embodiment.

FIG. 6 schematically shows the simplest example table used for the correction computation (step S14) performed in the control unit 33.

FIG. 7 is a graph illustrating the spectrum, that is, the wavelength dependence of intensity, of the emitted light in the case where a red LED is used as a light source 10.

FIG. 8 is a graph showing the wavelength range of the propagating light G2.

FIG. 9 is a graph showing the temperature variation of the emitted light spectrum of the LED.

FIG. 10 is a graph illustrating the guidable wavelength range in the case where the spectrum has temperature variation.

FIG. 11 is a graph showing the temperature variation in the intensity of the propagating light G2.

FIG. 12 is a graph showing the result of calculating the number of reflections for L=5 mm and t=10 μm.

FIG. 13 is a graph showing the temperature variation of the normalized spectrum of the guided light.

FIG. 14 is a graph showing the temperature variation of the wavelength dependence of the expectation value of the number of reflections.

FIG. 15 is a graph showing the temperature dependence of the expectation value of the number of reflections integrated with respect to wavelength and the variation ratio of the number of reflections.

FIG. 16 is a schematic cross-sectional view of a color reaction detecting device according to an example of the invention.

### DETAILED DESCRIPTION OF THE INVENTION

An embodiment of the invention will now be described with reference to the drawings.

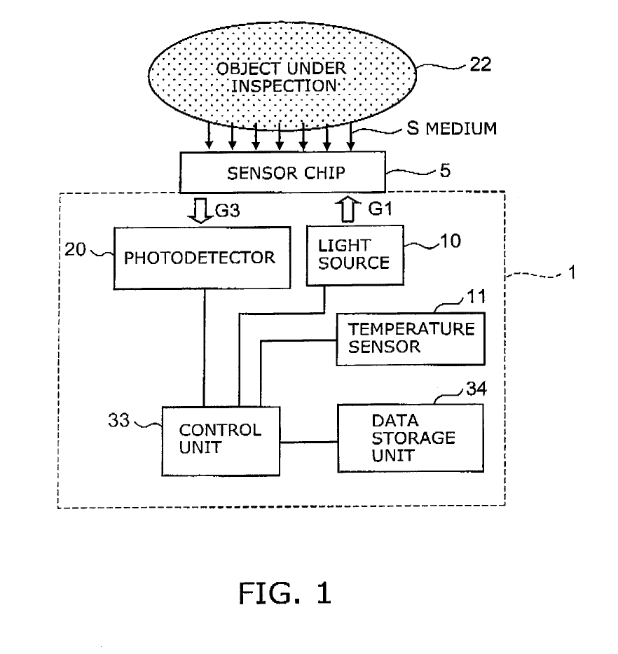

FIG. 1 is a block diagram of a color reaction detecting device according to an embodiment of the invention.

The color reaction detecting device 1 of this embodiment comprises a light source 10, a photodetector 20, a temperature sensor 11, a data storage unit 34, and a control unit 33 connected to them. In measurement, a sensor chip 5 is detachably attached and irradiated with emitted light G1 from the light source 10. The sensor chip 5 is brought into contact with an object under inspection 22 such as a human arm or abdomen. A prescribed medium S released from the object under inspection 22 and diffused into the sensor chip 5 induces color reaction. This color reaction is sensed by the photodetector 20, and arithmetically processed in the control unit 33. Thus the amount of medium S released from the object under inspection 22 can be determined.

Here, when the color reaction detecting device 1 is brought into contact with a human arm or the like in measurement, the temperature of the device increases due to body temperature. This causes variation in the wavelength of the light source 10 and the like, and hence errors occur in the measurement. However, in this embodiment, a temperature sensor 11 is provided so that the temperature of the light source 10 and the like can be measured. The temperature data measured by the temperature sensor 11 is sent to the control unit 33. Upon the variation of temperature, the control unit 33 performs correction computation based on the temperature correction data stored in the data storage unit 34 so that the temperature-dependent wavelength drift and other effects can be canceled. As a result, the color reaction detecting device can achieve high accuracy with reduced measurement errors despite any variation in the temperature of the color reaction detecting device 1.

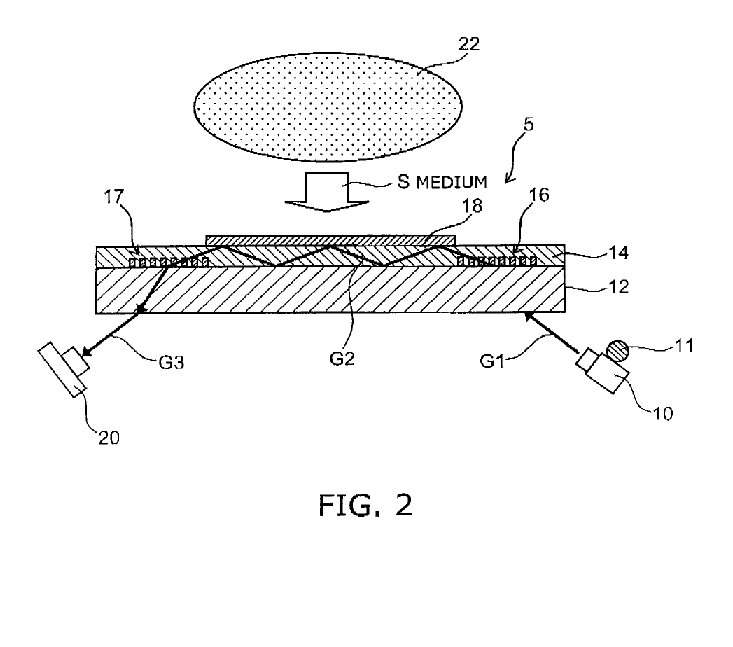

FIG. 2 is a schematic cross-sectional view showing the optical unit in the color reaction detecting device of this embodiment.

As shown in FIG. 2, in measurement, a sensor chip 5 is attached to the optical unit of the color reaction detecting device. The sensor chip 5 has a structure in which a waveguide layer 14 and a thin film 18 are laminated in this order on a substrate 12. Emitted light G1 from the light source 10 made of an LED (Light Emitting Diode) or other light emitting element is incident on the substrate 12 at an incident angle in a prescribed range. On one end of the upper surface of the substrate 12 is provided a first grating 16 for controlling the propagating direction of the emitted light G1. On the other end of the upper surface of the substrate 12 is provided a second grating 17 for extracting the propagating light G2 that propagates in the waveguide layer 14. The waveguide layer 14 covers the first and second grating 16, 17, and the thin film 18 is provided on the upper surface of the waveguide layer 14.

The propagating light G2, which is introduced through the first grating 16 into the waveguide layer 14 and propagates therein, is extracted through the second grating 17 and is incident on the photodetector 20. The intensity of the incident light G3 is measured. The thin film 18 is brought into contact with an object under inspection 22 such as a human arm to be tested. A medium S to be detected is released from the object under inspection 22 and intrudes into the thin film 18. Then color development occurs due to chemical reaction with the material contained in the thin film 18. Upon color development, part of the propagating light G2 that propagates in the waveguide layer 14 is absorbed to cause a loss, and its intensity decreases. Hence, by measuring the intensity of the incident light G3 by the photodetector 20, the amount of medium S released from the object under inspection 22 can be determined.

According to this embodiment, a temperature sensor 11 such as a thermistor is placed near the light source 10 to measure the operating temperature of the light source 10. On the basis of the measurement result, the measurement error associated with the temperature variation can be corrected.

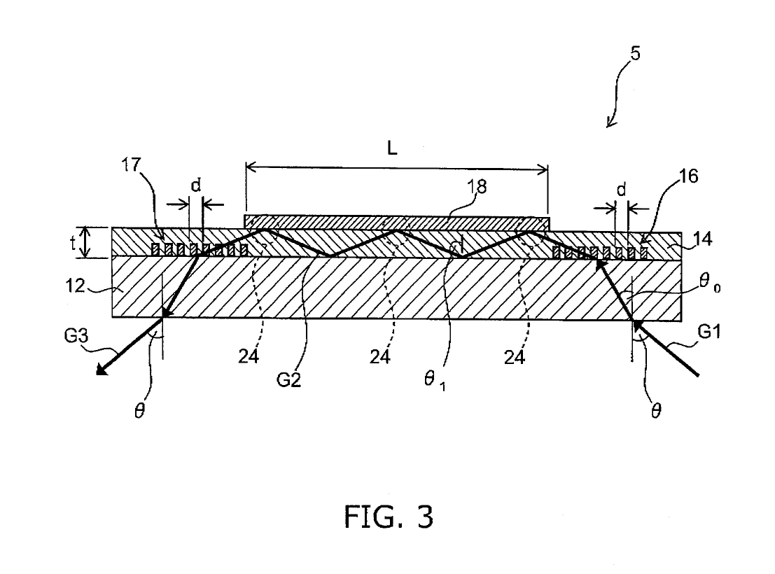

FIG. 3 is a schematic cross-sectional view for illustrating the optical function in more detail.

The emitted light G1 is incident on the backside of the substrate 12 at incident angle θ. The substrate 12 is illustratively made of glass (with a refractive index of about 1.5). Hence, in the case of incidence from air, the angle of refraction θ₀ is smaller than θ.

Upon arrival at the upper surface of the substrate 12, the emitted light G1 produces refracting light by the first grating 16 formed on the upper surface of the substrate 12. The first and second grating 16, 17 are illustratively made of silicon dioxide (SiO₂, with a refractive index of about 1.3). The intensity of refracting light and the angle of refraction can be controlled by varying the pitch d and depth of the grating depending on the wavelength of the emitted light. The first and second grating 16, 17 can be illustratively formed by a microfabrication process using a photoresist.

Furthermore, a waveguide layer 14 covers the first and second grating 16, 17. The waveguide layer 14 is illustratively made of resin having a refractive index of about 1.56, and can be formed by spincoating and curing. A thin film 18 illustratively made of resin having a refractive index of about 1.3 is further provided on the upper surface of the waveguide layer 14. The thin film 18 contains a material that reacts with the medium released from the object under inspection and develops a color. Evanescent waves, which are generated when the propagating light G2 is reflected at the interface with the thin film 18, are absorbed by the developed color. That is, when color development occurs in the thin film 18, optical absorption occurs in the absorption region 24, and the loss of the propagating light G2 increases.

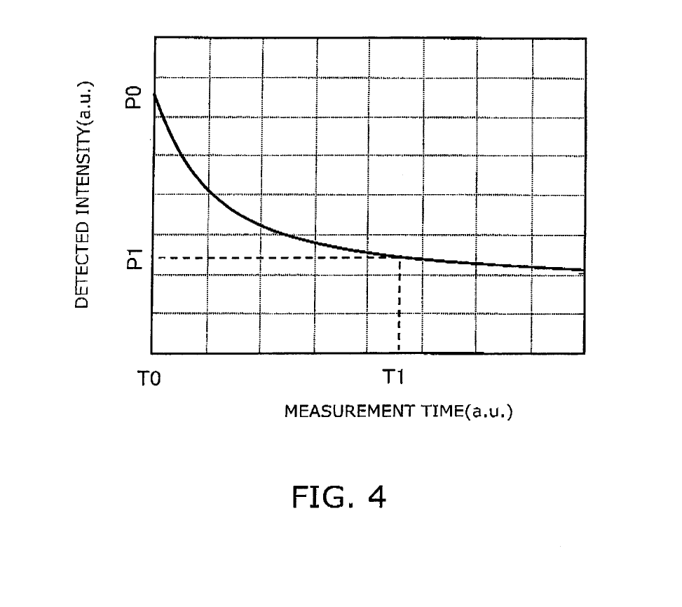

FIG. 4 is a graph conceptually showing the temporal variation in the intensity of incident light G3 detected by the photodetector 20 in measurement.

More specifically, the measurement begins by bringing the sensor chip 5 into contact with an object under inspection such as a human arm. Then a medium S is diffused from the object under inspection into the thin film 18 (see FIG. 2), and a color reaction proceeds. The color reaction proceeds relatively rapidly in the early phase. Hence the detected intensity in the photodetector 20 decreases relatively rapidly. With the decrease of the rate of color reaction, the decrease of the detected intensity in the photodetector 20 also becomes gradual. Hence the amount of color development, that is, the amount of medium S, can be determined by comparing the detected intensity P0 at the beginning T0 with the detected intensity P1 at time T1 when a prescribed period of time has elapsed after the start of measurement, or at time T1 when the temporal variation of the detected intensity falls below a prescribed value.

In this embodiment, in determining the amount of medium S in this manner, temperature variation is taken into consideration. That is, the measurement by the temperature sensor 11 (see FIGS. 1 and 2) is referenced. When the temperature varies during measurement, its effect is taken into consideration to determine the amount of medium S.

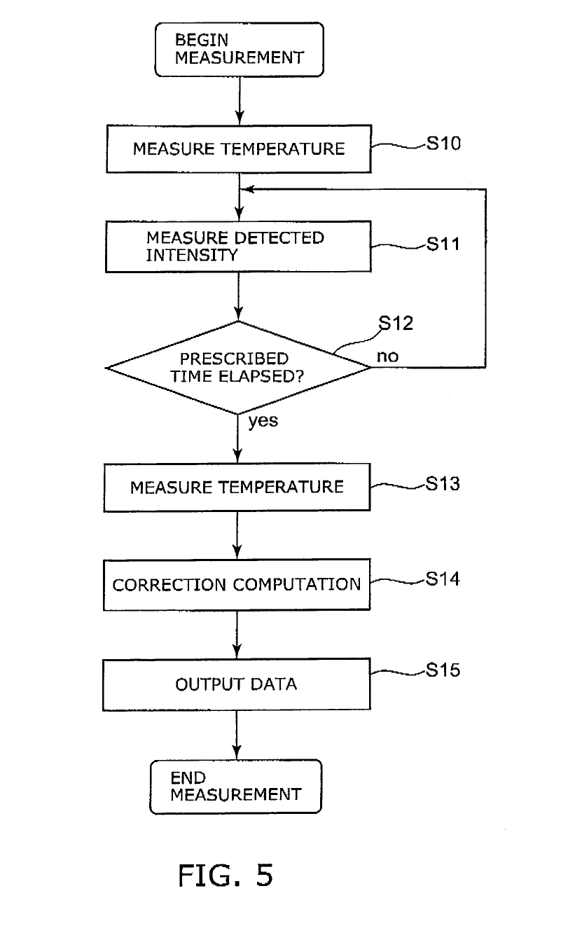

FIG. 5 is a flow chart illustrating the flow of measurement in the color reaction detecting device 1 of this embodiment.

After the beginning of measurement, initially (T=T0), the temperature is measured by the temperature sensor 11 (step S10). Here it is also possible to wait for the optical power of the light source 10 to be relatively stabilized before starting the measurement and measuring the temperature. Then the sensor chip 5 is irradiated with the emitted light G1 from the light source 10, and the incident light G3 is detected by the photodetector 20 (step S11). After the measurement of the initial detected intensity P0, the detected light intensity gradually decreases as described above with reference to FIG. 4.

For example, if a prescribed period of time (T=T1) has elapsed, or if the temporal variation of the detected light intensity falls below a prescribed value (step S12, yes), then the detected light intensity P1 is taken as the final measurement data, and the temperature is measured by the temperature sensor 11 (step S13).

The data of the detected light intensity from the photodetector 20 and the temperature data from the temperature sensor 11 are sent to the control unit 33 (see FIG. 1), where correction computation is performed in consideration of temperature variation (step 514). Then data regarding the amount of medium S determined in consideration of the effect of temperature variation is outputted (step S15). As described later in detail, the data regarding the amount of medium S can be displayed on the display unit attached to the color reaction detecting device 1 or outputted to an external device.

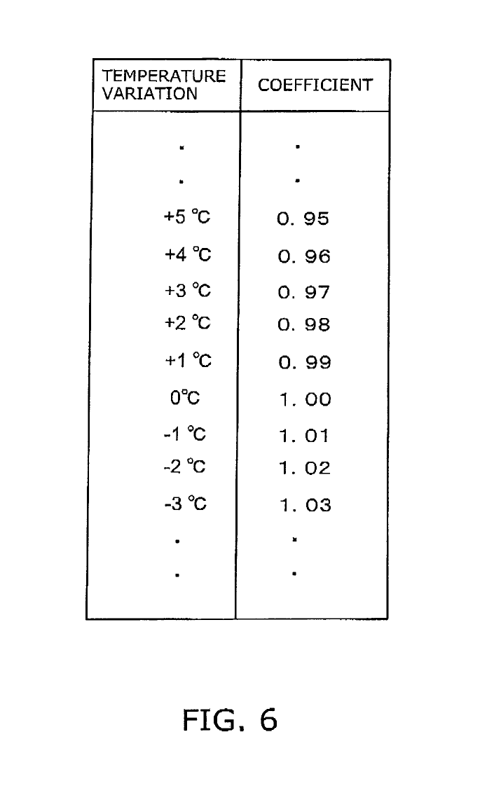

FIG. 6 schematically shows the simplest example table used for the correction computation (step S14) performed in the control unit 33.

If the temperature varies during measurement, the power and wavelength of the emitted light G1 emitted from the light source 10 may vary. The power variation of the emitted light G1 can be restricted through feedback control of the light source 10 using APC (automatic power control) or other techniques. However, it is not easy to restrict the wavelength variation. As described later in detail, variation in wavelength of the light source 10 causes variation in intensity of light that can be introduced as the propagating light G2 in the sensor chip 5. On the other hand, variation in wavelength causes the variation of the optical path of the propagating light G2 inside the sensor chip 5. This causes variation, for example, in the number of reflections between the waveguide layer 14 and the thin film 18, and hence the loss due to absorption in the absorption region 24 (see FIG. 3) varies.

Thus temperature variation during measurement affects the detected intensity in the photodetector 20 in an overlapping manner. In this embodiment, such effects of temperature variation are examined beforehand by measurement or simulation, and temperature correction data based thereon is prepared and stored in the data storage unit 34. The table illustrated in FIG. 6 shows an example of temperature correction data thus stored in the data storage unit 34.

In the table illustrated in FIG. 6, a coefficient is assigned to each temperature variation. Here the temperature variation is illustratively defined as the temperature variation at the final time (T=T1) with reference to the temperature at the initial time (T=T0) of measurement. On the other hand, the coefficient is illustratively defined as a coefficient multiplying the detected intensity that is detected in the photodetector 20.

In the table illustrated in FIG. 6, when the temperature variation is zero, the coefficient is 1.00. That is, the control unit 33 directly uses the detected intensity outputted from the photodetector 20 to determine the amount of medium S. On the other hand, as the temperature variation increases as +1° C., +2° C., +3° C., . . . , the coefficient decreases as 0.99, 0.98, 0.97, . . . . That is, if the temperature increases during measurement, the control unit 33 corrects the detected intensity measured by the photodetector 20 in a decreasing direction. However, this is for illustrative purpose only. The detected intensity may be corrected in an increasing direction as the temperature increases. Furthermore, the table shown in FIG. 6 is merely a simplest example. Alternatively, for example, a plurality of parameters related to the detected intensity in the photodetector 20 can be defined, and a particular temperature dependence can be assigned to each parameter. The effect of temperature variation is described later in detail.

In the following, the embodiment of the invention is described in more detail with reference to examples.

First, the propagation condition of light introduced into the waveguide layer 14 of the sensor chip 5 is described.

The waveguide layer 14 of the sensor chip 5 has a greater refractive index than the substrate 12 and the thin film 18. Hence, if the shape of the gratings 16, 17, the thickness and refractive index of each component, and the incident angle θ satisfy the following relational expressions, then the propagating light G2 propagates in the waveguide layer 14 while repeating total reflection, passes through the second grating 17 provided at the other end of the substrate 12, and is emitted outside as incident light G3 on the photodetector 20.

θ₁=sin⁻¹[(sinθ+λ/d)/n₁] (1)

θ₁<90 deg (2)

θ₁>sin⁻¹(n₀/n₁) (3)

n₁>n₀ (4)

n₁>n₂ (5)

n₂>n₀ (6)

where

θ: incident angle on the backside of the substrate

θ₀: angle of refraction

θ₁: guiding angle in the waveguide layer

n₀: refractive index of the substrate

n₁: refractive index of the waveguide layer

n₂: refractive index of the thin film

d: pitch of the grating

λ: wavelength of the emitted light

Next, a description is given more specifically with reference to numerical examples.

First, let n₁=1.50, n₀=1.46, λ=655 nm, and d=1000 nm. From formulas (1) and (2), θ<57.67 deg. On the other hand, from formulas (1) and (3), θ>53.61 deg. That is, the range of incident angle θ allowing the propagating light G2 to propagate in the waveguide layer 14 while repeating total reflection is 53.61<θ<57.67 (deg). Here “total reflection” means that the incident angle is greater than the critical angle, and includes the case where absorption of evanescent waves occurs in the absorption region 24 of the thin film 18 adjacent to the waveguide layer 14.

The emitted light G1 from the light source 10 has a wavelength distribution In the range determined by the structure of the light source 10. For example, when the light source 10 is a semiconductor light emitting element, the emitted light wavelength is continuously distributed in a wide range of 605 to 705 nm. AS a result, when the wavelength is 605 nm, 58.76<θ<63.51 (deg). When the wavelength is 705 nm, 49.02<θ<52.66 (deg). That is, in the wavelength range of 605 to 705 nm, the propagating light G2 undergoing total reflection exists if 49.02<θ<63.51 (deg).

Next, a method for estimating the variation of the guided light intensity is described.

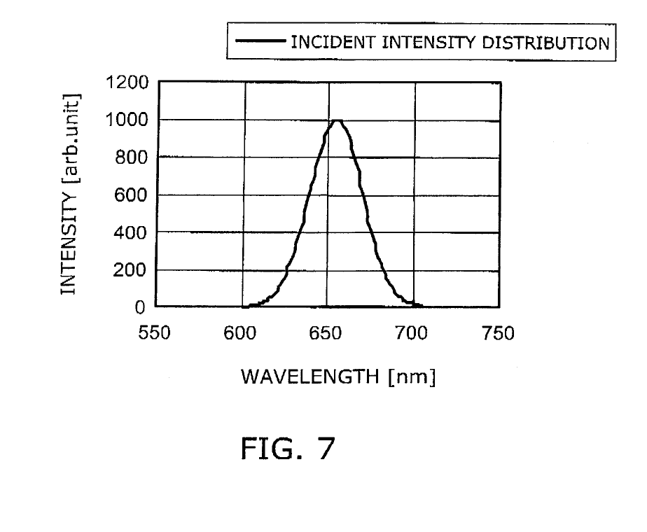

FIG. 7 is a graph illustrating the spectrum, that is, the wavelength dependence of intensity, of the emitted light in the case where a red LED is used as a light source 10. The vertical axis represents intensity in relative value, and the horizontal axis represents wavelength (in nm). The peak wavelength is 655 nm, and the wavelength is continuously distributed in the range of about 605 to 705 nm. This wavelength (λ) dependence of the emitted light intensity (I) can be approximated by the following formula:

I(λ)=1000×exp(−((λ−655)/22)²) (7)

The incident angle is illustratively assumed as θ=55.0 deg in the range of 49.02<θ<63.51 (deg). Furthermore, it is assumed that n₁=1.50, n₀=1.46, and d=1000. For total reflection in the waveguide layer 14, the formulas (1) to (3) need to be satisfied. Because these relational expressions include the emitted light wavelength λ, the incident light on the backside of the substrate 12 is not entirely guided. Here the total reflection condition is satisfied when 641 nm <λ<680 nm.

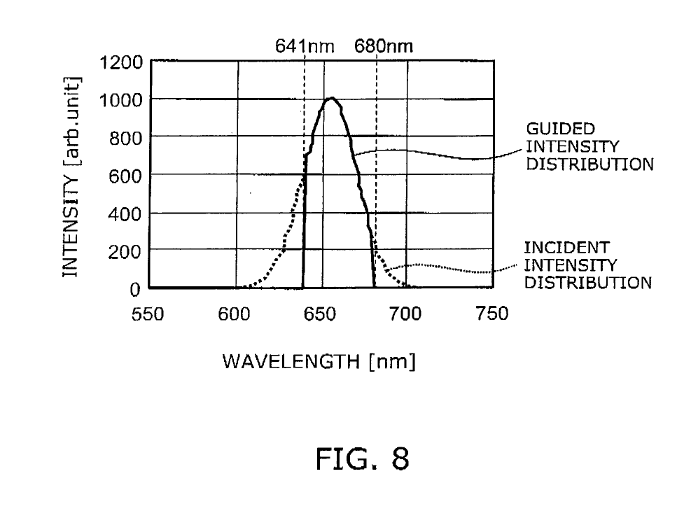

FIG. 8 shows that the propagating light G2 does not exist in the wavelength range of λ<641 nm and λ>680 nm. That is, for λ<641 nm, the propagating light G2 is not totally reflected at the interface with the substrate 12 and passes from the waveguide layer 14 to the substrate 12. For λ>680 nm, the emitted light G1 is reflected between the substrate 12 and the waveguide layer 14 and is not introduced into the waveguide layer 14.

Next, a description is given of the temperature variation of the guided light intensity where the emitted light G1 from the light source 10 is diffracted by the first grating 16 and introduced into the waveguide layer 14.

The wavelength dependence of the intensity of light emitted from the light source 10 varies with temperature. When the light source 10 is an LED, the wavelength dependence of the emitted light intensity is entirely shifted to the longer wavelength side with the increase of temperature while maintaining substantially the same shape.

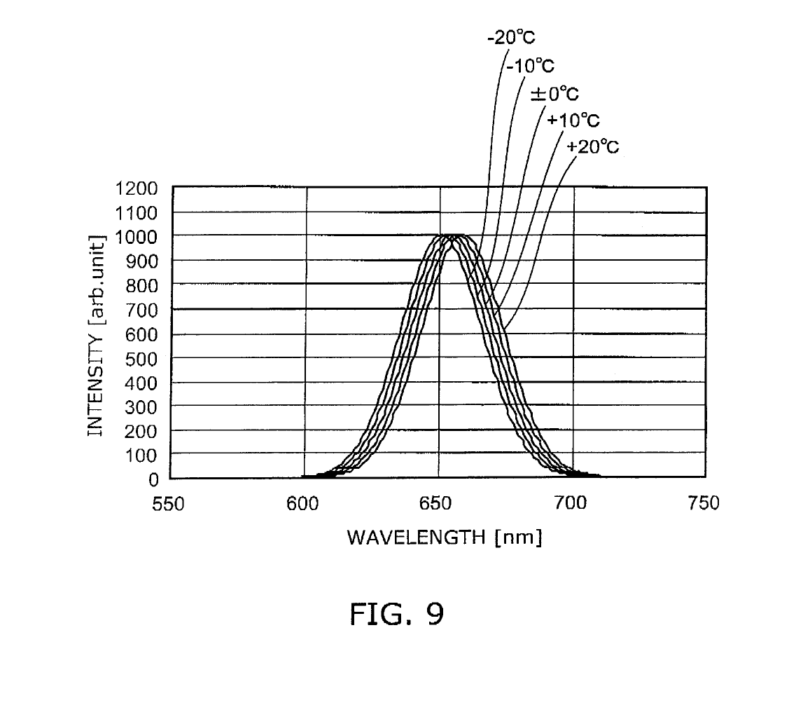

FIG. 9 is a graph showing the temperature variation of the emitted light spectrum of the LED. The vertical axis represents relative intensity, and the horizontal axis represents wavelength. The intensity of the emitted light G1 of the LED is preferably controlled to a constant value by an APC (Automatic Power Control) circuit based on a photodiode. FIG. 9 shows the wavelength dependence for temperature variation ΔT of −20° C., −10° C., ±0° C., +10° C., and +20° C. with reference to 25° C. This spectrum, that is, wavelength dependence of intensity, can be approximated by the following formula:

I(λ)=1000×exp[−{(λ−(655+0.2×ΔT))/22}²] (8)

For temperature variation ΔT=+20° C., the spectral curve is shifted to the long wavelength side by about +4 nm. For temperature variation ΔT=−20° C., the spectral curve is shifted to the short wavelength side by about −4 nm.

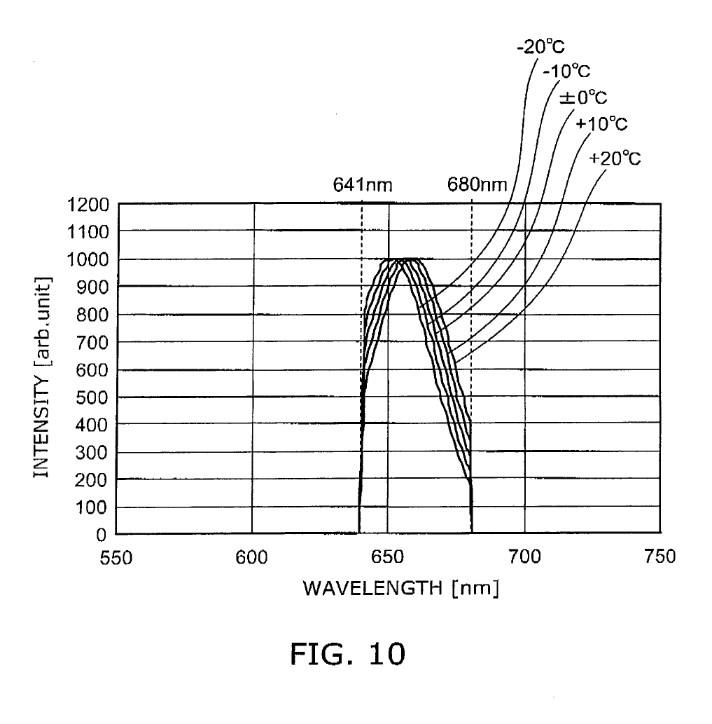

FIG. 10 is a graph illustrating the guidable wavelength range in the case where the spectrum has temperature variation. The intensity of the propagating light G2 shown in FIG. 10 integrated with respect to wavelength corresponds to the initial value of the measured light intensity guided at each temperature. More precisely, this integrated value multiplied by the diffraction efficiency is the measured initial value.

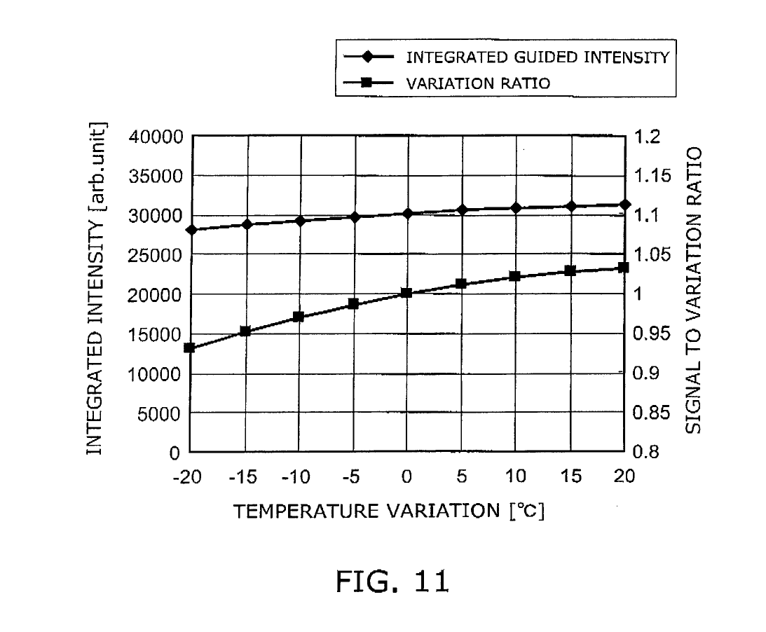

FIG. 11 is a graph showing the temperature variation in the intensity of the propagating light G2. That is, with the temperature variation of the light source 10, the spectrum of the light source 10 and propagation varies. In FIG. 11, the left vertical axis represents the integrated intensity obtained by integrating the wavelength dependence shown in FIG. 10 in increments of 1 nm, and the right vertical axis represents signal to variation ratio. The horizontal axis represents temperature variation ΔT. When the light source 10 having the characteristics illustrated in FIG. 7 is used, the integrated intensity representing the measured light intensity increases by about 1% at ΔT=+5° C., and a little less than 4% at ΔT=+20° C. The integrated intensity decreases by a little more than 1% at ΔT=−5° C., and about 6% at ΔT=−20° C.

Variation in the intensity of the propagating light G2 in the waveguide layer 14 upon the variation of temperature can be estimated from FIG. 11. For example, assume that color reaction measurement is started at the reference temperature ΔT=0° C. and that after 30 seconds, the measured light intensity has decreased by 50%. If ΔT=0° C. after 30 seconds, the signal variation associated with color reaction equals the variation of the measured light intensity, i.e., 50%. If ΔT=+5° C. after 30 seconds, the guided light intensity is considered to have increased by +1% during measurement, and the signal variation or decrease due to color reaction can be estimated as 51 (=50+1) %. Similarly, if ΔT=−5° C. after 30 seconds, the signal variation due to color reaction can be estimated as 49 (=50−1) %. Thus it is possible to correct the variation of the guided light intensity due to the temperature variation of the light source 10 producing the emitted light G1.

Next, a description is given of the temperature variation in the number of reflections of the propagating light G2 that propagates with total reflection in the waveguide layer 14. That is, if the temperature varies, the wavelength of light emitted from the light source 10 varies. Hence the optical path of the propagating light G2 in the waveguide layer 14 also varies. This also causes variation in the number of total reflections undergone by the propagating light G2 in the waveguide layer 14.

The angle of reflection at which the propagating light G2 having a wavelength of 641 to 680 nm undergoes total reflection on the waveguide layer 14 as illustrated in FIG. 8 is referred to as the guiding angle θ₁ and expressed by formula (1). Total reflection occurs at the interface between the waveguide layer 14 and the substrate 12 and at the interface between the waveguide layer 14 and the thin film 18. The total number of reflections is expressed by the following formula:

Number of reflections=L/(t×tanθ₁) (9)

where

L: Length of the thin film in the guiding direction

t: Thickness of the waveguide layer

Here, the number of reflections on the thin film 18, which are associated with the absorption of evanescent waves in the absorption region 24, only accounts for about half of this total number.

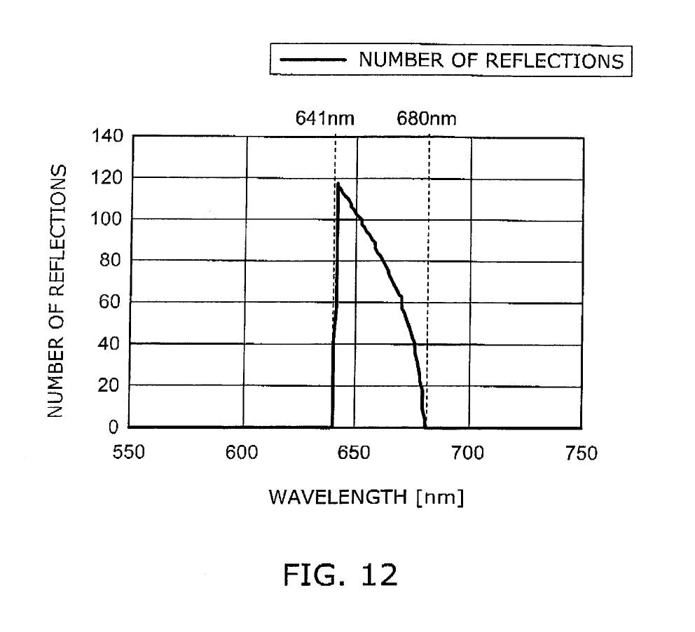

FIG. 12 is a graph showing the result of calculating the number of reflections for L=5 mm and t=10 μm. The guided light component having a wavelength of 641 nm reflects about 115 times. The number of reflections decreases with the increase of wavelength, and vanishes at a wavelength of 680 nm.

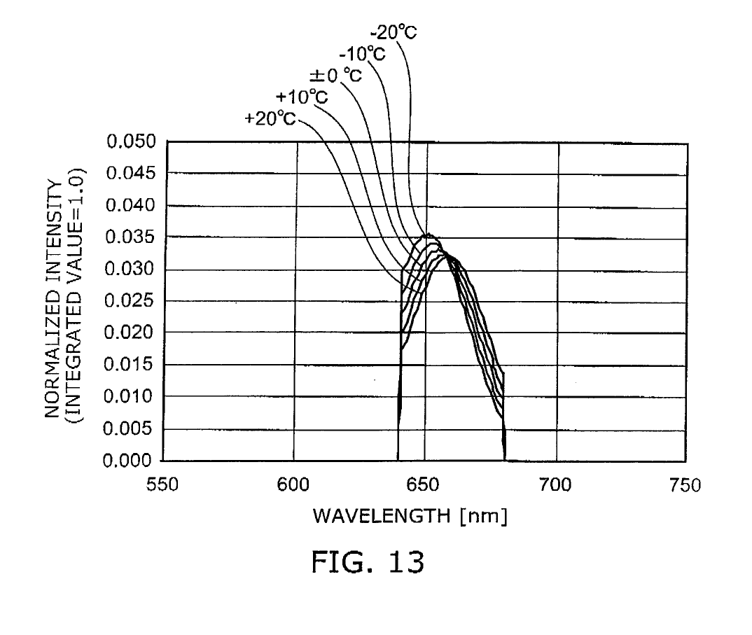

FIG. 13 is a graph showing the temperature variation of the normalized spectrum of the guided light. When the light source 10 is an LED, the wavelength of the propagating light G2 increases with the increase of temperature, and hence the number of reflections decreases. First, the peak intensity of the spectrum of the guided light illustrated in FIG. 10 is normalized so that its integrated value is 1.0. That is, if the intensity curve representing each spectrum is integrated in increments of 1 nm, then the result is 1.0. FIG. 13 shows the temperature variation of the spectrum thus normalized.

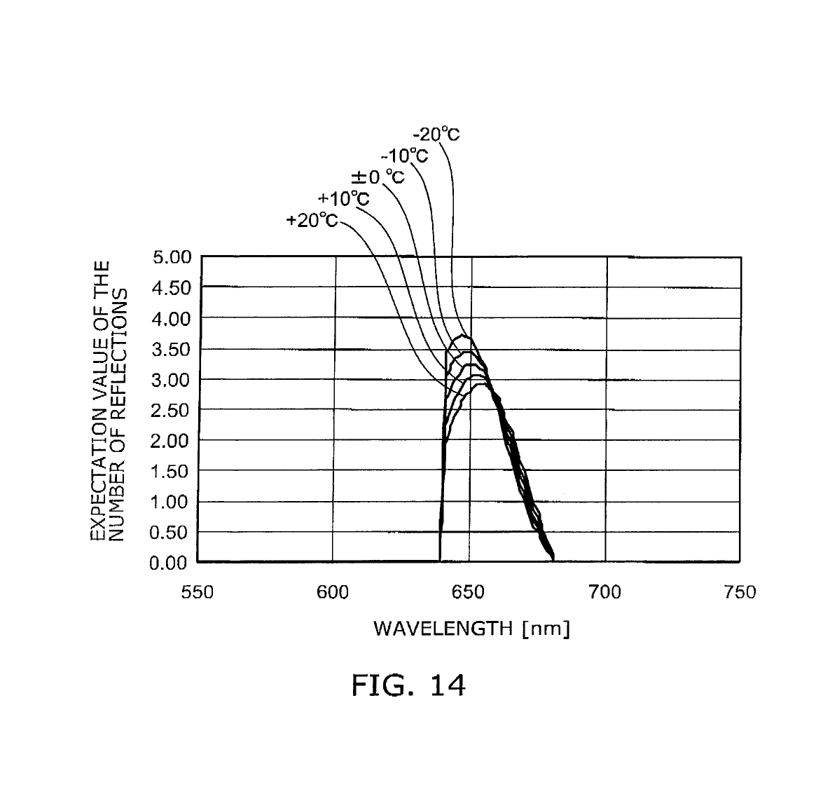

FIG. 14 is a graph showing the temperature variation of the wavelength dependence of the expectation value of the number of reflections. The graph shows the result of multiplication where the number of reflections shown in FIG. 12 is multiplied by the normalized intensity shown in FIG. 13 in increments of 1 nm. The vertical axis represents the expectation value of the number of reflections, and the horizontal axis represents wavelength. As ΔT increases from −20° C. to +20° C., the peak of the expectation value of the number of reflections is decreased and shifted to the long wavelength side.

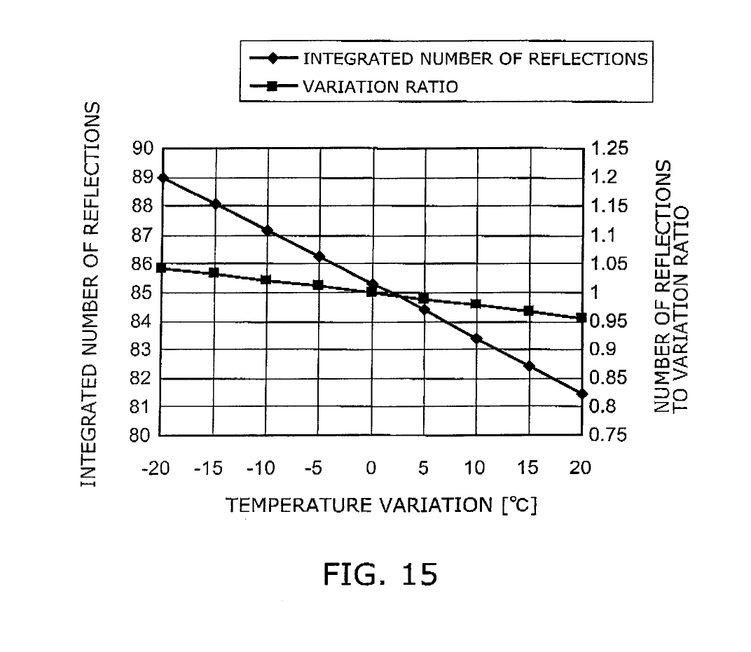

FIG. 15 is a graph showing the temperature dependence of the expectation value of the number of reflections integrated with respect to wavelength and the variation ratio of the number of reflections. The vertical axis corresponds to the average number of reflections of the propagating light G2 obtained by integrating the expectation value of the number of reflections in wavelength increments of 1 nm. The horizontal axis represents temperature variation ΔT.

The average number of reflections of the propagating light G2 is 85.3 at ΔT=0° C., and the average number of reflections decreases to 81.5 at λT =+20° C. On the other hand, the average number of reflections increases to 89 at ΔT=−20° C. In terms of the number of reflections to variation ratio, the number of reflections decreases almost linearly from +5% to −5% for the temperature variation from −20° C. to +20° C.

The temperature variation of the amount of absorption of evanescent waves occurring in the absorption region 24 shown in FIG. 3 is highly correlated with this variation of the number of reflections. For example, assume that color reaction measurement is started at ΔT=0° C. and that after 30 seconds, the measured light signal intensity has decreased by 50%. If ΔT=0° C. after 30 seconds, the signal variation associated with color reaction equals the variation of the measured light intensity, i.e., 50%. If ΔT=+20° C. after 30 seconds, the variation of the guided light intensity is 4%, and the measurement error in the amount of color reaction due to the variation in the number of reflections of the propagating light G2 is −5%. Hence the net signal variation due to color reaction can be estimated accurately as (50+4)×1.05=56.7 (%).

Next, an example of the color reaction detecting device of this embodiment is described.

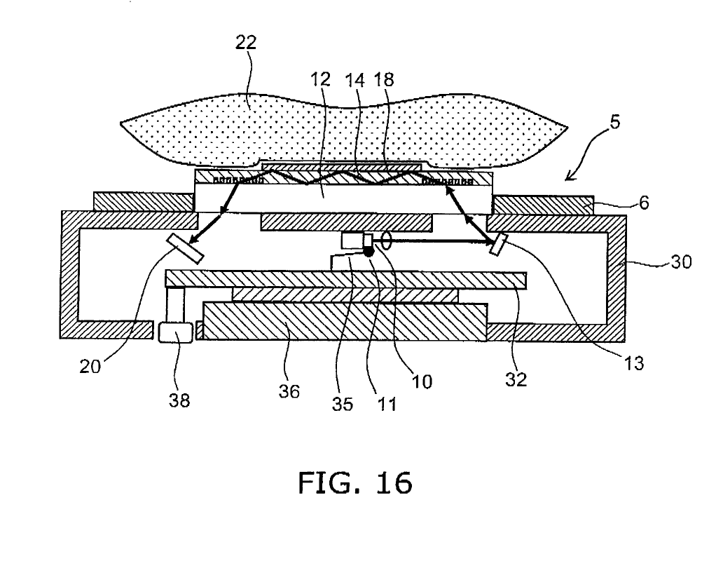

FIG. 16 is a schematic cross-sectional view of a color reaction detecting device according to an example of the invention. A housing 30 made of resin or the like is provided with a support 6 to which a sensor chip 5 can be attached. A light source 10 is provided in the housing 30. Emitted light G1 travels along a suitable optical system including a reflecting mirror 13, passes through a transmissive portion provided in the housing 30, and is incident on a substrate 12 of the sensor chip 5. On the other hand, the light extracted from the substrate 12 is sensed by a photodetector 20 included in the housing 30. The housing 30 also includes a controller board 32 and a liquid crystal display 36. The light source 10, the photodetector 20, and the liquid crystal display 36 are electrically connected to the controller board 32. Furthermore, an operating switch 38 is fixed to the housing 30 or the controller board 32. The sensor chip 5 is detachable for replacement after use. The structure of this example illustrated in FIG. 16 is suitable to portable compact devices. Hence, for example, it can be attached to a human arm or abdomen with a belt, not shown, to measure the prescribed medium released from the human body, and thereby inspection can be easily conducted.

According to this embodiments a temperature sensor 11 is provided near the light source 10, for example, and its detected result is outputted through wiring 35 to the controller board 32. In response to variation in the temperature detected by the temperature sensor 11, the controller board 32 performs computation in consideration of the variation in the wavelength of light emitted from the light source 10 and the variation of the optical path of the guided light in the waveguide layer 14 as described above with reference to FIGS. 1 to 15. As a result, the color reaction detector can reduce measurement errors due to temperature variation.

The light source 10 can illustratively be an LED of the SMD (surface mounting device) type. To detect its temperature variation, for example, a temperature sensor 11 such as a thermistor or thermocouple can be pressure welded or bonded to the surface of the SMD.

Manufacturing of a color reaction detecting device of this example illustrated in FIG. 16 can include, illustratively during or after the assembling process, a process of populating the data storage unit 34 (see FIG. 1) provided on the controller board 32 with temperature variation data for the emitted light G1 and propagating light G2 as described above with reference to FIGS. 1 to 15. A simplest example of such data is described above with reference to FIG. 6. Alternatively, for example, the temperature variation data as illustrated in FIGS. 11 and 15 can be inputted as numerical data into a ROM (read only memory) provided on the controller board 32. More specifically, assuming that the operating environment of the device is prescribed as 20 to 22° C., the numerical data as shown in TABLE 1 can be illustratively stored.

TABLE 1

| | | | | Guided | Num. of |
|---|---|---|---|---|---|
| | | Measure | Measure | light | reflections |
| | Reference | start | end | variation | variation |
| Case | temp. | temp. | temp. | ratio | ratio |
| A | 21 | 20 | 20 | ±0% | ±0% |
| B | 21 | 20 | 21 | +1% | −1% |
| C | 21 | 20 | 22 | +2% | −2% |
| D | 21 | 21 | 20 | −1% | +1% |
| E | 21 | 21 | 21 | ±0% | ±0% |
| F | 21 | 21 | 22 | +1% | −1% |
| G | 21 | 22 | 20 | −2% | +2% |
| H | 21 | 22 | 21 | −1% | +1% |
| I | 21 | 22 | 22 | ±0% | ±0% |

Then, for an actual measurement where the temperature at the beginning of measurement is 20.2° C. and the temperature at the end of measurement is 21.8° C., the nearest data in the database of TABLE 1 is data C. Thus data C is selected, and a variation ratio of the guided light intensity of +2% and a variation ratio of the number of reflections of −2% can be retrieved to easily estimate the net signal variation due to color reaction.

Alternatively, the temperature dependence of the spectrum of the emitted light G1 from the light source 10 as described above with reference to FIG. 9 can be stored in the data storage unit 34 so that the control unit 33 can perform correction computation depending on the measurement of the temperature sensor 11.

As described above, according to this example, the temperature variation of the guided light intensity after diffraction in the first grating 16 is estimated to correct the variation in the intensity of incident light on the photodetector 20. Thus the amount of color reaction can be determined with high accuracy. Furthermore, through computation of the temperature variation in the total number of reflections, the temperature variation in the amount of absorption of evanescent waves of the propagating light G2 is estimated to correct the variation in the intensity of incident light on the photodetector 20. Thus the amount of color reaction can be determined with higher accuracy.

In the case of manufacturing a plurality of color reaction detecting devices, the data regarding temperature dependence stored in the data storage unit 34 may be common to every device, or the data actually measured for each device may be used. For example, if the light source 10 has a small individual difference in temperature characteristics, the same data regarding temperature dependence can be used. On the other hand, if the light source 10 has a large individual difference in temperature characteristics, preferably, data regarding temperature dependence is measured for each color reaction detecting device and stored in the data storage unit 34.

According to this example, there is no need for the component for restricting the temperature variation of the light source. Hence the device can be downsized and is suitable to portable applications. Furthermore, because there is no need for the time until the temperature is stabilized, measurement can be rapidly performed. Moreover, the measurement accuracy can be ensured because of the temperature correction function.

The embodiment of the invention has been described with reference to the drawings. However, the invention is not limited to the above examples. For example, the shape, size, and material of the light source, temperature sensor, substrate, waveguide layer, grating, thin film, and photodetector constituting the color reaction detecting device that are variously adapted by those skilled in the art are also encompassed within the scope of the invention as long as they do not depart from the spirit of the invention.

1. A color reaction detecting device comprising:
a support configured to support a sensor chip, the sensor chip including a thin film which causes a color reaction by a substance released from an object under inspection;
a light source configured to introduce light into the sensor chip supported by the support;
a photodetector configured to sense light emitted from the sensor chip;
a temperature sensor configured to measure temperature; and
a control unit configured to compute an amount of color reaction in the sensor chip using a result of the sensing by the photodetector and a result of the measurement by the temperature sensor.

2. The color reaction detecting device according to claim 1, wherein the control unit detects a change in temperature during sensing by the photodetector.

3. The color reaction detecting device according to claim 2, wherein the control unit corrects errors due to temperature variation which occurs during the sensing by the photodetector.

4. The color reaction detecting device according to claim 1, further comprising:
a data storage unit configured to store data for correcting an error caused by a change in temperature during sensing by the photodetector,
wherein the control unit uses the data depending on the result of the measurement by the temperature sensor.

5. The color reaction detecting device according to claim 1, wherein the sensor chip includes a substrate, a waveguide layer provided on the substrate, and the thin film provided on the waveguide layer.

6. The color reaction detecting device according to claim 5, further comprising:
a data storage unit for storing data regarding temperature dependence of intensity of the light emitted from the light source and propagating in the waveguide layer.

7. The color reaction detecting device according to claim 6, wherein the control unit uses the data depending on the result of the measurement by the temperature sensor.

8. The color reaction detecting device according to claim 5, further comprising:
a data storage unit for storing data regarding temperature dependence of number of reflections that the light emitted from the light source and propagating in the waveguide layer undergoes at an interface between the waveguide layer and the thin film.

9. The color reaction detecting device according to claim 8, wherein the control unit uses the data depending on the result of the measurement by the temperature sensor.

10. The color reaction detecting device according to claim 1, wherein the temperature sensor is configured to measure a change in temperature of the light source.

11. The color reaction detecting device according to claim 1, wherein the waveguide layer has a first grating which diffract a light introduced from the light source and propagates through the waveguide layer.

12. The color reaction detecting device according to claim 11, wherein the waveguide layer has a second grating which diffract a light introduced from the light source and propagates through the waveguide layer.

13. The color reaction detecting device according to claim 11, wherein the support detachably supports the sensor chip.

14. A method for manufacturing a color reaction detecting device, the color reaction detecting device including a support for supporting a sensor chip, a light source for introducing light into the sensor chip supported by the support, a photodetector for sensing light emitted from the sensor chip, a temperature sensor for measuring temperature, a data storage unit, and a control unit for computing an amount of color reaction in the sensor chip, the method comprising:
storing, in the data storage unit, data for correcting errors due to temperature variation which occurrs during the sensing by the photodetector.

15. The method for manufacturing a color reaction detecting device according to claim 4, further comprising:
before the step of storing, emitting light from the light source at a plurality of temperatures and obtaining the data.

16. The method for manufacturing a color reaction detecting device according to claim 4, wherein same data are stored in the data storage units of a plurality of the color reaction detecting device.

17. The method for manufacturing a color reaction detecting device according to claim 1, wherein the sensor chip includes a substrate, a waveguide layer provided on the substrate, and the thin film provided on the waveguide layer, and
the data are data regarding temperature dependence of intensity of the light emitted from the light source and propagating in the waveguide layer.

18. The method for manufacturing a color reaction detecting device according to claim 1, wherein the sensor chip includes a substrate, a waveguide layer provided on the substrate, and the thin film provided on the waveguide layer, and
the data are data regarding temperature dependence of number of reflections that the light emitted from the light source and propagating in the waveguide layer undergoes at an interface between the waveguide layer and the thin film.

19. The method for manufacturing a color reaction detecting device according to claim 14, wherein the control unit detects a change in temperature during sensing by the photodetector.

20. The method for manufacturing a color reaction detecting device according to claim 19, wherein the control unit corrects errors due to temperature variation which occurs during the sensing by the photodetector.
